(19) United States
(12) Patent Application Publication
(10) Pub. No.: US 2008/0267019 A1
(43) Pub. Date: Oct. 30, 2008

(54) Optical Pickup Apparatus and Optical Disk Drive

(76) Inventors: Shigeharu Kimura, Yokohama (JP); Takeshi Shimano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/870,461

(22) Filed: Oct. 11, 2007

(30) Foreign Application Priority Data
Apr. 27, 2007 (JP) 2007-119044

(51) Int. Cl. G11B 21/08

(52) U.S. Cl. 369/44.12

(57) ABSTRACT

When tracking a dual-layer optical disc by a differential push-pull method, the adverse effect of the reflected light from an adjacent layer, which produces stray light, on a tracking control signal is prevented. A split wavelength plate 20 is inserted in the optical path of the reflected light from the optical disc including the stray light from the adjacent layer so as to detect a region having no interference with the stray light with a four-quadrant detector, and then a push-pull signal by a sub-beam is formed.

### CLAIM OF PRIORITY

The present application claims priority from Japanese application JP2007-119044 filed on Apr. 27, 2007, the content of which is hereby incorporated by reference into this application.

### BACKGROUND OF THE INVENTION

1. Field of the Invention

The present invention relates to optical pickup apparatuses and optical disc drives, and particularly to an optical pickup apparatus and an optical disc drive having features in their reading optical systems.

2. Background Art

The capacity of an individual layer of an optical disc greatly depends on the wavelength of the semiconductor laser used and the numerical aperture (NA) of the objective lens. Specifically, the shorter the wavelength of the semiconductor laser, or the greater the NA, the greater the recording density can be made, with the resultant increase in the capacity per layer. Most of the currently commercially available optical disc drives are the DVD (Digital Versatile Disc) drives that employ red light with wavelengths in the vicinity of 650 nm and objective lenses with NA 0.6. Shipping of optical disc drives with recording densities that exceed those of DVDs has started, the disc drives using a blue-violet semiconductor laser having a light wavelength near 405 nm as a light source, and an objective lens with NA 0.85. While it is desirable to shorten the wavelength used from the viewpoint of future increase in recording density, development of a semiconductor laser light source with wavelengths shorter than blue-violet is expected to be difficult because such wavelengths would be in the ultraviolet range. Furthermore, since the limit of NA of an objective lens in air is 1, it is also difficult to achieve an increase in recording density by increasing the NA of the objective lens.

Under such circumstances, it has been prior art to employ dual recording layers so as to increase the capacity of an individual optical disc. Non-patent document 1 discloses a technology concerning a dual-layer phase-change disc. When a dual-layer optical disc is irradiated with laser light, crosstalk between layers becomes an issue because an adjacent layer is simultaneously irradiated. In order to reduce this problem, it has been conventional practice to increase the interval between the layers. Since the laser light is focused and layers other than a target layer are displaced from the position where the laser light is focused, crosstalk can be reduced.

However, such increase in the layer interval leads to the problem of spherical aberration. Between the recording layers, polycarbonate is used, which has a different refractive index from that of air, and it causes spherical aberration. Since the objective lens is designed such that its spherical aberration is minimized with respect to a particular layer, spherical aberration develops when the focal point of laser light is moved to another layer. Such aberration can be corrected by placing an expander lens optical system, which typically consists of two lenses, or a liquid crystal element, in front of the objective lens. By changing the distance between the two lenses or the phase of the liquid crystal element, aberration can be corrected. However, given the range of possible compensation by the liquid crystal element or the need to realize a lens moving mechanism within a small-sized optical disc drive apparatus, large spherical aberrations cannot be corrected. Namely, it is difficult in practice to increase the layer interval in a dual-layer optical disc in the context of optical drive apparatuses. Thus, there still remains the problem of interlayer crosstalk in multilayer optical discs.

As one method of reducing the aforementioned crosstalk, Patent Document 1 proposes placing a very small mirror on the optical axis. Since the position of focus of reflected light from the multilayer optical disc, on which light is focused with a lens, differs on the optical axis between a target layer and an adjacent layer, it becomes possible to obtain the reflected light from the target layer alone using the very small mirror placed on the optical axis, and to reduce crosstalk. However, since this method involves bending the reflected light from the optical disc laterally with respect to the optical axis, an increase in the size of the optical pickup is inevitable. Patent Document 2 proposes a method involving a critical angle prism to eliminate reflected light from the adjacent layer. This method, taking advantage of the fact that the reflected light from the relevant layer becomes collimated parallel light whereas the reflected light from the adjacent layer becomes diverging light or converging light, aims to eliminate those rays that have come to assume more than a certain angle with respect to the optical axis, using a critical angle prism. This method, however, also results in an inevitable increase in the size of the optical pickup because of the use of two critical prisms.

Patent Document 1: JP Patent Publication (Kokai) No. 2005-302084 A

Patent Document 2: JP Patent Publication (Kokai) No. 2002-367211 A

Non-patent document 1: Jpn. J. Appl. Phys. Vol. 42 (2003) pp. 956-960

### SUMMARY OF THE INVENTION

With reference to FIG. 3, crosstalk in a multilayer optical disc in a detection optical system of an optical pickup apparatus is described, on the assumption that a tracking error signal is detected by the DPP (Differential Push-Pull) method. The DPP method involves dividing laser light into a single main beam and two sub-beams using a diffraction grating, and the optical disc is irradiated with such beams. FIG. 3 shows only a main beam 80. For simplicity's sake, numeral 501 designates a double-layer optical disc and numerals 511 and 512 designate information recording layers. The position of minimum beam spot of the main beam 80 from the objective lens 401 is on the information recording layer 511, from which information is to be read. On the information recording layer 511, guide grooves are formed as shown in FIG. 4 for tracking purposes. As shown, one of the grooves is being irradiated with the main beam having an optical spot 94, while the sub-beams impinge at positions displaced by a half-track pitch, forming irradiated spots 95 and 96. Since the focal point of the irradiation light is aligned with the recording layer 511, the reflected light travels backward along the same path as that of the incident light and returns to an objective lens 401 of FIG. 3. The reflected light further passes through a detection lens 402 and then becomes incident on a photodetector 51 in the form of a light beam 81. The detection lens 402 is provided with an astigmatism at an angle of 45° with respect to the direction of the grooves, and the photodetector 51 is disposed at the position of the circle of least confusion.

FIG. 5 shows the configuration of photodetectors and how the reflected light from the optical disc becomes incident thereon. At the center is a four-quadrant detector 541 for the detection of the main beam, which forms a spot 811 as the detector 541 is irradiated therewith. Reflected light by the sub-beam becomes incident on split detectors 542 and 543 and form optical spots 812 and 813, respectively. The four-quadrant detector 541 produces signals A, B, C, and D. The split detector 542 produces signals E and F. The split detector 543 produces signals G and H. A tracking error signal TR is expressed by TR=(A+B)−(C+D)−k{(E−F)+(G−H)}, where k is a constant that is determined by the ratio of intensity of main beam to sub-beams, for example. Normally, the intensity of the main beam is set to be ten or more times the intensity of the sub-beams. When a focusing error signal is AF and a data signal is RF, AF=A+D−(B+C), and RF=A+C+B+D. TR and AF signals are used for the control of the laser light irradiation position.

The dual-layer optical disc is so designed that when it is irradiated with laser light, the individual layers produce substantially the same amount of reflected light. Thus, the layer closer to the objective lens has a greater transmittance so as to allow the irradiation of a layer farther from the objective lens with laser light. Under such condition, when the focal point of the laser light is aligned with the information reading target layer 511, as shown in FIG. 3, some of the laser light passes through the relevant layer 511 as a light beam 82, which is reflected by the adjacent layer 512, resulting in a reflected light beam 83, which is stray light. The reflected light beam 83 returns to the objective lens 401, becomes incident on the detection lens 402, once focused in front of the photodetector 51, and then becomes incident on the photodetector 51 as it extends as shown by a light beam 84. The light beam 84 forms an expanded optical spot 841 on the photodetector surface, as shown in FIG. 5, by which the photodetectors 541, 542, and 543 are covered. As a result, the beam 84 interferes with the beams 811, 812, and 813. Such interference is under the influence of a change in the phase of the optical spot 841 caused by a fluctuation in the interlayer distance, and it fluctuates. The fluctuation of the interference greatly influences the TR signal. Since the intensity of the sub-beams produced by the splitting in the diffraction grating is designed to be small, the intensity of the sub-beams is on the same order as the power density of the reflected light of the main beam from the adjacent layer. Consequently, the effect of interference appears strongly. If the distribution of the amount of light in the optical spot 812 or 813 is changed by the rotation of an optical disc having an uneven interlayer distance, the differential signal portion SPP=(E−F)+(G−H) of the TR signal due to the sub-beams is influenced, leading to an imbalance in the tracking error signal. This can result in problems such as a tracking error. Similarly, if the adjacent layer 512 is closer to the objective lens than the reading target layer 511, reflected light is produced by the adjacent layer and causes interference in the same way.

It is therefore an object of the invention to reduce crosstalk into a tracking error signal in a dual-layer optical disc without an increase in the size of the optical pickup apparatus.

In order to achieve the above object, the polarization distribution of the reflected light from the optical disc is modified, so that, in a portion where the polarization distribution of stray light from an adjacent layer due to the main beam and the polarization distribution of the sub-beams overlap each other, a portion can exist in which the polarizations are perpendicular to each other. Since in this portion of the sub-beams there is no interference, it becomes possible to form and obtain a TR signal having reduced fluctuations by using the light in this portion. This method is advantageous in that it requires simply the insertion of a wavelength plate in the optical path for changing polarization and does not result in an increase in the size of the optical system.

The invention is described with reference to FIGS. 6 and 7 in greater details. Referring to FIG. 6, numeral 20 designates a split wavelength plate, which is inserted in the optical path of the reflected light from the optical disc via the objective lens 401 and the detection lens 402 of FIG. 3. The intensity distribution of the reflected light from the dual-layer optical disc on the wavelength plate is composed of regions 851, 852, and 853 where the main beam from the relevant layer is dominant. These regions are formed because of the grooves formed in the recording layer as shown in FIG. 4. Since the width of the grooves is designed to be sufficiently narrow, diffracted light of the zero-order light and the ±first-order light are strongly produced. The zero-order light and the ±first-order light interfere with each other within the area of the effective diameter of the optical system, producing the intensity distribution. The zero-order light exists widely throughout the effective diameter of the optical system, while the positive first-order light is present in the region 852, and the negative first-order light is present in the region 853. Therefore, in the region 852, the zero-order light and the positive first-order light interfere with each other, and in the region 853, the zero-order light and the negative first-order light interfere with each other. The split wavelength plate 20 is divided equally between the regions 852 and 853, with the line of division extending perpendicular to the track direction of the optical disc. The polarization direction of the reflected light from the optical disc that is incident on the split wavelength plate is linear polarization. In the following description, for simplicity's sake, the first wavelength plate 201 is assumed to be a λ/2 plate having the function to change the polarization direction of the transmitted light by 90° into a first polarization state. The second wavelength plate 202 is assumed not to change the polarization direction of the transmitted light with respect to the incident light, in order to obtain a second polarization state. The transmitted light whose polarization has been modified is focused by the detection lens 402 having astigmatism at the angle of 45° with respect to the track direction of the recording layer, and detected at the position of the circle of least confusion.

FIG. 7 illustrates the polarization states. Numeral 821 designates the polarization state of reflected light from the relevant layer due to the main beam. Numerals 822 and 823 designate the polarization states of reflected light from the relevant layer due to the sub-beams. There is no change in polarization state in the upper half of each of the beams on the sheet of the drawing (831, 833, and 835); namely, they are in the second polarization state. In the lower half (832, 834, and 836), the polarization state is rotated by 90°, resulting in the first polarization state. Thus, the polarization states are reversed with respect to the 45′-axis of astigmatism. On the other hand, the reflected light from the adjacent layer due to the main beam, which is stray light, extends widely as indicated by a large circle 842, having different polarization distributions on the left and right of the sheet. If the adjacent layer is located nearer to the objective lens than the relevant layer, the polarization direction is rotated by 90° (first polarization state) in the region 843, while the polarization direction remains the same (second polarization state) in the region 844.

When the stray light 842 and the sub-beams 822 and 823 from the relevant layer are compared in terms of polarization direction, it can be seen that in the regions 833 and 836, the polarization directions are the same while they are perpendicular in the regions 834 and 835. Interference occurs when the polarizations are in the same direction and does not occur when they are perpendicular to each other. Therefore, an SPP signal having reduced fluctuation can be obtained by means of the sub-beams in the regions 834 and 835.

FIG. 8 illustrates a polarization distribution in the case where the adjacent layer is located farther from the objective lens than the relevant layer is. In this case, the position of focus of the reflected light from the adjacent layer due to the main beam is located toward the detection lens, and a reflected light image 842 due to the adjacent layer is reversed relative to FIG. 7 at the position of the circle of least confusion of the reflected light from the relevant layer. For this reason, the polarization state in the region 845 does not change (second polarization state), while the polarization state is changed by 90° (first polarization state) in the region 846. The polarization state of the reflected light from the relevant layer is the same as in FIG. 7. Therefore, interference occurs between the regions 834 and 835, while no interference is caused between the regions 833 and 836. This indicates that the region of no interference shifts from 834 to 833 and from 835 to 836 when the relevant layer is switched in dual layers.

The reflected light from the dual-layer optical disc is detected with detectors configured as shown in FIG. 9. The shape of a detector 541 for the detection of main beam is the same as FIG. 5; namely it consists of four quadrants. In addition, each of detectors 544 and 545 for the detection of sub-beams also consists of four quadrants. The four-quadrant detector 544 produces outputs e, f, g, and h. The four-quadrant detector 545 produces outputs i, j, m, and n. In a case where the adjacent layer of the dual-layer optical disc is located closer to the objective lens 401 than the relevant layer is, the polarization state of the reflected light from the optical disc is as shown in FIG. 9, which is the same as FIG. 7. Since the outputs e and g of the four-quadrant detector 544 and the outputs j and n of the four-quadrant detector 545 are not subject to interference, the SPP signal=(e−g)+(j−n). In this case, the tracking error signal TR=(A+B)−(C+D)−k{(e−g)+(j−n)}. In a case where the relevant layer is closer to the objective lens 401, the polarization distribution of the reflected light from the optical disc becomes as shown in FIG. 8, where the outputs that are not subject to interference are the outputs f and h of the four-quadrant detector 544 and the outputs i and m of the four-quadrant detector 545. The SPP signal=(f−h)+(i−m), and the tracking error signal TR in this case=(A+B)−(C+D)−k{(f−h)+(i−m)}. Thus, by appropriately using portions of the sub-beams having no interference depending on the relevant layer, the fluctuation in the SPP signal can be reduced.

In the foregoing description, the polarization direction of the reflected light from the optical disc was given a change of 90° using only the first wavelength plate 201 of the split wavelength plate 20. In principle, it is possible to change the polarization direction of the transmitted light in both the first wavelength plate 201 and the second wavelength plate 202. However, the same effect can be obtained as long as the first polarization state and the second polarization state are perpendicular to each other. The same effect can also be obtained where the transmitted light in the first wavelength plate 201 and the second wavelength plate 202 is circularly polarized light, by making the direction of rotation of polarization of both opposite to each other.

In the following, an example is described in which the split wavelength plate 21 of FIG. 10 is placed on the optical path, instead of the split wavelength plate 20 of FIG. 6. The distribution in regions 851, 852, and 853 of the amount of reflected light from the optical disc is the same as in FIG. 6 and is therefore not further described. The line of division of the split wavelength plate 21 is drawn so as to divide the patterns 852 and 853 made by the first-order light from the optical disc in the middle, rather than intersecting them. Namely, the division line is in parallel to the track direction of the optical disc. For simplicity's sake, it is assumed that the first wavelength plate 211 has no influence on the transmitted light, that the polarization state of the transmitted light is in the first polarization state, and that the polarization direction (second polarization state) of the transmitted light of the second wavelength plate 212 alone is rotated by 90°. The transmitted light from the split wavelength plate 21 is focused by the detection lens 402 having astigmatism of 45° with respect to the track direction of the optical disc and then detected at the position of the circle of least confusion.

If the adjacent layer is closer to the objective lens, the reflected light from the adjacent layer is represented on the detector surface by two large semicircles 853 and 854 shown in FIG. 11. The polarization direction in the region 853 remains unchanged in the first polarization state. The polarization direction of the region 854 is rotated by 90° into the second polarization state. The reflected light from the relevant layer impinges on the four-quadrant detectors 541, 544, and 545; the light with which the four-quadrant detectors 544 and 545 are irradiated is due to the sub-beams. The distribution of polarization direction of the sub-beams on the detectors is similar to the shape of the polarization distribution of FIG. 10 folded along the line that passes through the center at an angle of 45°. Therefore, the polarization direction is rotated by 90° (second polarization state) in the left-semicircle portion of each, while the polarization direction remains unchanged (first polarization state) in the right-semicircle portion of each. In view of both the polarization direction of the light from the adjacent layer and the polarization direction of the light from the relevant layer, the outputs of the photodetector from portions without interference are f, g, j, and m. Thus, by forming a SPP signal due to the sub-beams using these outputs, the fluctuation in the SPP signal due to interference can be reduced. In this case, the SPP signal=(f−g)+(j−m), and the TR signal=(A+B)−(C+D)−k{(f−g)+(j−m)}. If the relevant layer and the adjacent layer are switched, the polarization distribution of the reflected light from the adjacent layer is reversed in FIG. 11. As a result, the outputs of the four-quadrant detector 544 and 545 having no interference are e, h, i, and n, so that the SPP signal=(e−h)+(i−n) and the TR signal=(A+B)−(C+D)−k{(e−h)+(i−n)}.

Even when the division direction of the split wavelength plate is changed, the effect of reducing interference can be provided as long as the wavelength plates act to cause the polarization directions of the transmitted light to become perpendicular to each other. The same effect would not be lost, either, in the case of both of the wavelength plates converting into circularly polarized light as long as the direction of rotation of both transmitted lights are opposite to each other.

In accordance with the present invention, the split wavelength plate is inserted in the optical path of the reflected light from the dual-layer optical disc so as to create a portion in the sub-beam where there is no interference, by means of which portion a tracking signal with reduced fluctuation can be formed. Since the split wavelength plate is not thick, it does not result in an increase in the size of the optical pickup compared with conventional examples.

### EFFECTS OF THE INVENTION

In accordance with the present invention, a portion in the sub-beams where no interference with the reflected light from the adjacent layer is caused can be detected, so that the fluctuation in the SPP signal can be reduced. This makes it possible to also reduce the fluctuation in the tracking error signal formed from the SPP signal, so that the optical spot can be prevented from losing track and the error in reading data can be reduced.

When an optical disc is written with information or data, an adjacent track is also irradiated with laser light, though in small amounts. If the displacement of the laser spot from a track is large, the amount of light onto the adjacent track increases, thereby possibly erasing the data in the adjacent track. In accordance with the invention, such displacement of the laser spot from a track can be reduced, whereby the amount of light onto the adjacent track can be reduced and the adverse effect of erasing the data in the adjacent track can be reduced.

### BRIEF DESCRIPTION OF THE DRAWINGS

FIG. 1 shows an optical system of an optical pickup apparatus according to the invention.

FIG. 2 shows an optical system of an optical pickup apparatus according to the invention.

FIG. 3 illustrates the influence of reflected light from an adjacent layer.

FIG. 4 shows a grooved recording surface being irradiated with one main beam and two sub-beams.

FIG. 5 shows the configuration of photodetectors, and the position and the expanse of an optical spot of the reflected light from the optical disc.

FIG. 6 shows a split wavelength plate having a dividing line in a direction perpendicular to the track direction of the optical disc.

FIG. 7 shows the polarization distribution of the reflected light from a relevant layer and the reflected light from an adjacent layer on the detection surface when the split wavelength plate of FIG. 6 is used.

FIG. 8 shows the polarization distribution of the reflected light from the relevant layer and the reflected light from the adjacent layer when the relevant layer has been changed.

FIG. 9 shows the configuration of photodetectors and a polarization distribution.

FIG. 10 shows a split wavelength plate having a dividing line in the track direction of the optical disc.

FIG. 11 shows the configuration of detectors and a polarization distribution on the detection surface of the reflected light from a relevant layer and the reflected light from and adjacent layer in a case where the split wavelength plate of FIG. 10 is used.

FIG. 12 shows a schematic diagram of a signal processing circuit in a case where the split wavelength plate of FIG. 6 is used.

FIG. 13 shows a schematic diagram of a signal processing circuit in a case where the split wavelength plate of FIG. 10 is used.

FIG. 14 shows sub-detectors of which the center is light-shielded.

FIG. 15 shows the result of calculation of fluctuation in the SPP signal by a conventional method in comparison with the present invention.

FIG. 16 shows the result of calculation of fluctuation in the SPP signal in a case where the sub-detector whose center is light-shielded has been used.

FIG. 17 shows a schematic diagram of an optical disc drive apparatus according to the invention.

FIG. 18 shows sub-detectors whose center is light-shielded.

### DESCRIPTION OF THE PREFERRED EMBODIMENTS OF THE INVENTION

In the following, embodiments of the invention are described with reference to the drawings.

### Embodiment 1

FIG. 1 shows an optical pickup apparatus for an optical disc drive. A semiconductor laser 101 emits laser light that is converted by a collimator lens 403 and a triangular prism 102 into a collimated, circular light beam. The collimated beam is divided into three beams by a diffraction grating 103; namely, one main beam and two sub-beams. While the direction of travel of the main beam is the same as the incident beam, the two sub-beams form emerging light having an inclination in symmetric directions with respect to the optical axis. Normally, the difference in the amount of light of the main beam and the sub-beams is set to be 10 times or greater. The three beams pass through a polarization beam splitter 104, converted by a quarter wavelength plate 105 into circularly polarized light, and then narrowed by an objective lens 404 onto a dual-layer optical disc 501 rotated by a rotation mechanism. In FIG. 1, the reading target layer (relevant layer) is 511, on which the minimum spot of the laser light is located. An adjacent layer 512 produces reflected light 83, which leads to stray light that causes crosstalk.

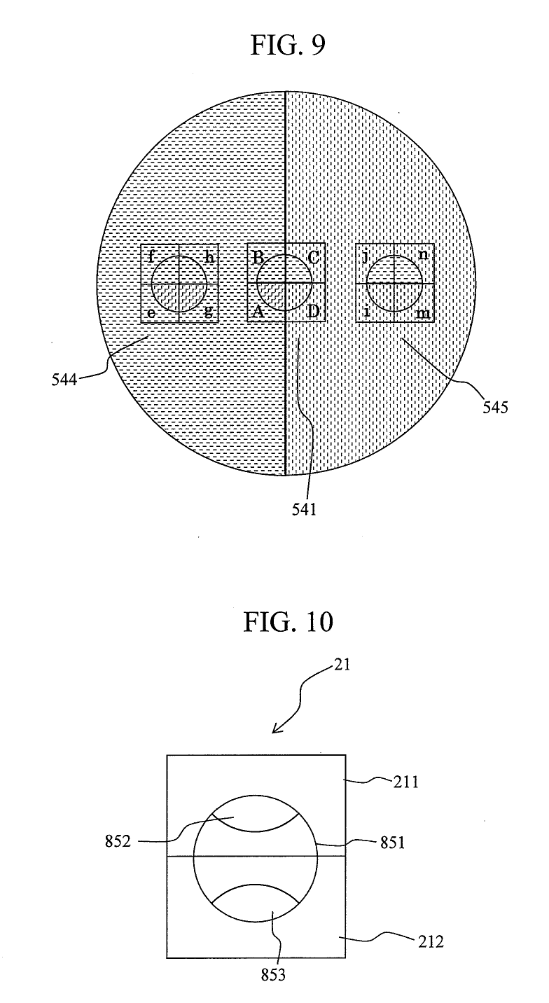

The reflected light from the dual-layer optical disc, including stray light, returns via the objective lens 404 and then converted by the quarter wavelength plate 105 into linear polarization in a direction perpendicular to the original polarization direction. As a result, the reflected light is reflected by the polarization beam splitter 104 and it travels toward a split wavelength plate 20. The split wavelength plate used herein is assumed to be the one shown in FIG. 6. Thus, the polarization direction of a half of the transmitted light is rotated by 90°. Thereafter, the transmitted light is focused by a condenser lens 405 having astigmatism, on a detector 52 disposed at the position of the circle of least confusion. An output signal from the detector is processed in a signal processing circuit 53 so as to form an AF signal and a TR signal for controlling the optical spot position, and an RF signal, which is a data signal. The sensitive portion of the photodetector 52 is shaped as shown in FIG. 9, where the detector portions for the detection of sub-beams comprise four-quadrant detectors.

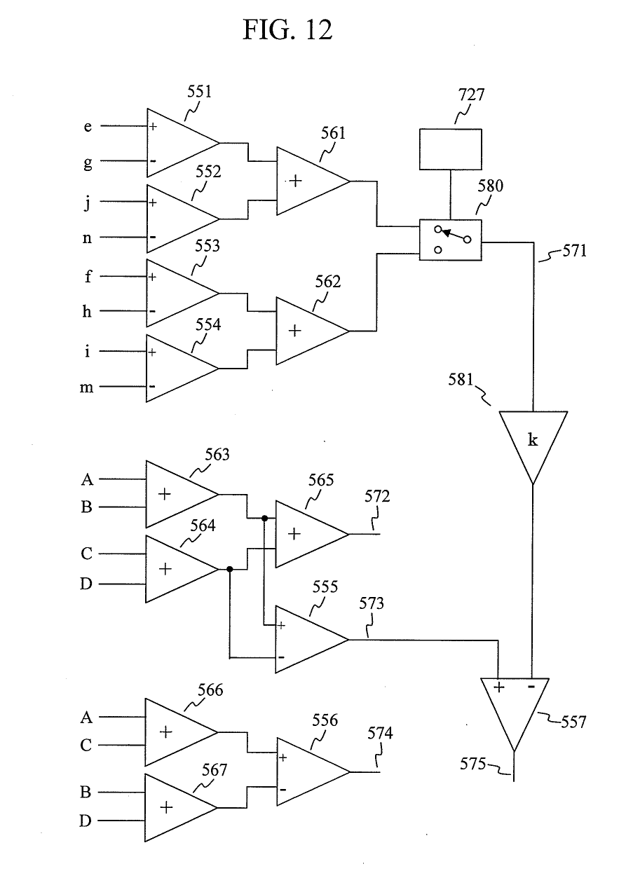

FIG. 12 shows an electronic circuit for signal processing. On the detector 52, the four-quadrant photodetectors 541, 544, and 545 shown in FIG. 9 are disposed. Outputs from these detectors are current-voltage converted to provide the inputs in the left part of FIG. 12. Inputs A, B, C, and D are provided by the outputs from the four-quadrant detector 541 that detect the main beam. Inputs e, g, f, h, j, n, i, and m are related to the outputs from the four-quadrant detectors 544 and 545 for the detection of sub-beams. Numerals 551 to 557 designate differential amplifiers; numerals 561 to 567 designate adder circuits. Numeral 727 designates a layer selection control circuit that controls the switching in a switching circuit 580 depending on whether or not the relevant layer is closer to or farther from the objective lens 404. The switching is conducted such that a sub-beam in a region where there is no interference with the reflected light from the adjacent layer is selected. Numeral 571 designates a sub-push-pull signal by a sub-beam having no influence of interference. Numeral 581 designates an amplifier with a factor k, which is a value determined in light of the ratio of intensity of the main beam to that of the sub-beam. Numeral 573 designates a push-pull signal by the main beam; this is processed in the differential amplifier 557 together with the output of 581, to provide a TR signal 575. The outputs A, B, C, and D from the four-quadrant detector 541 are all added up to provide a data signal 572. Numeral 574 designates an AF signal by the astigmatism method.

### Embodiment 2

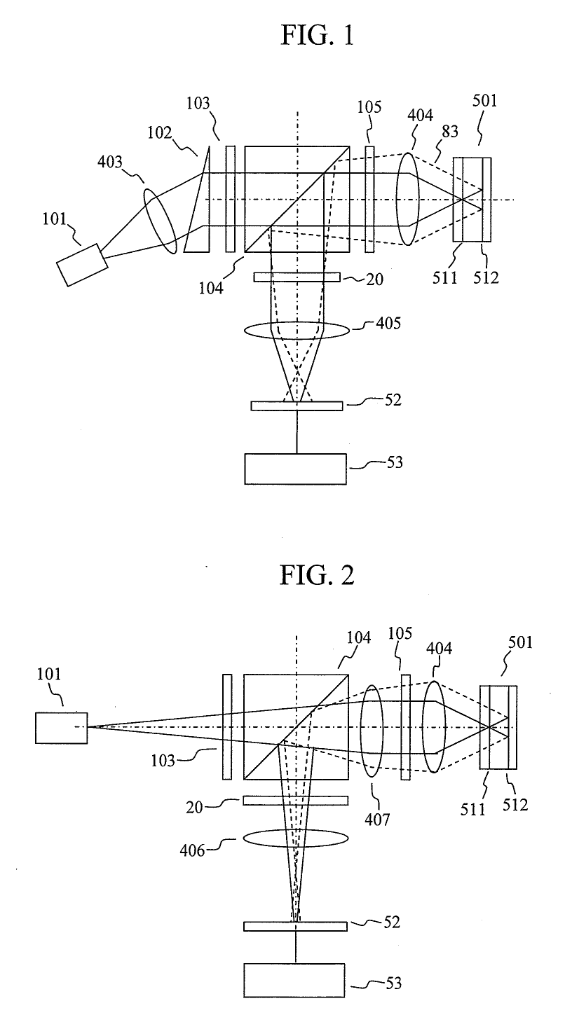

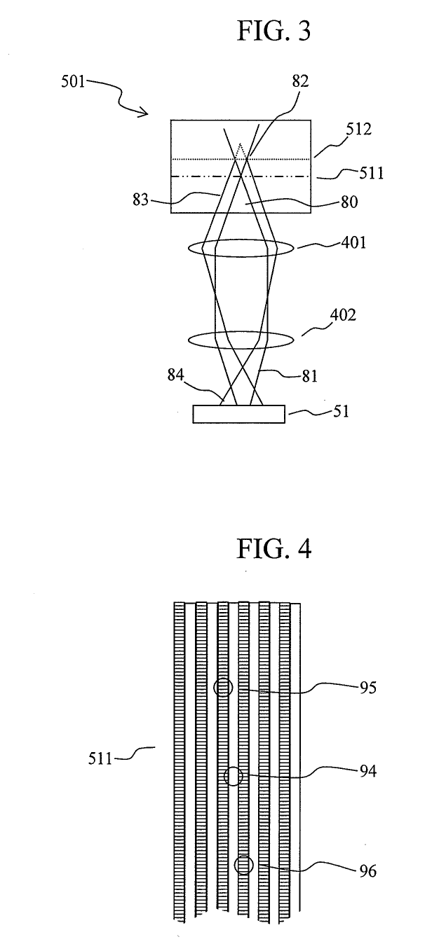

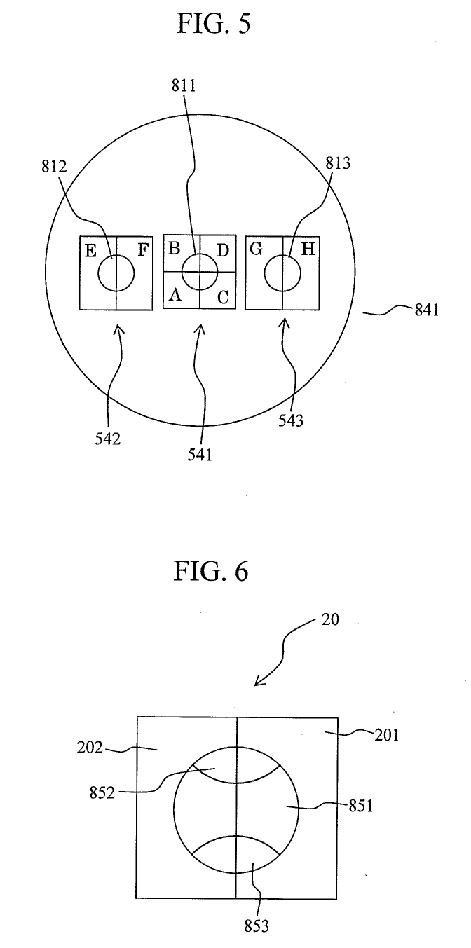

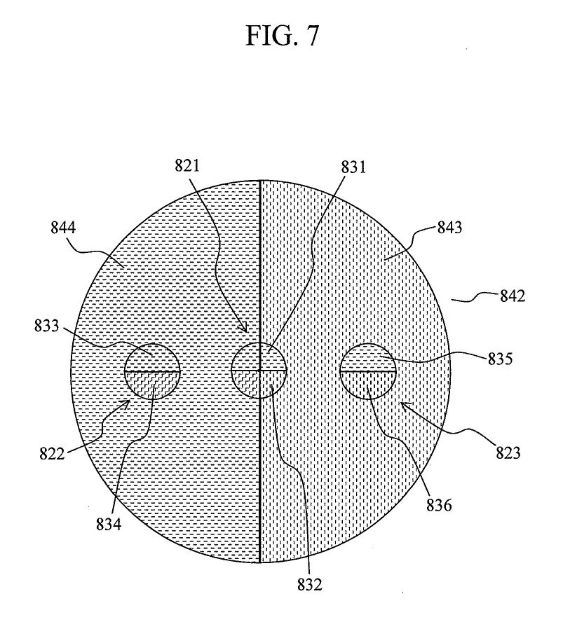

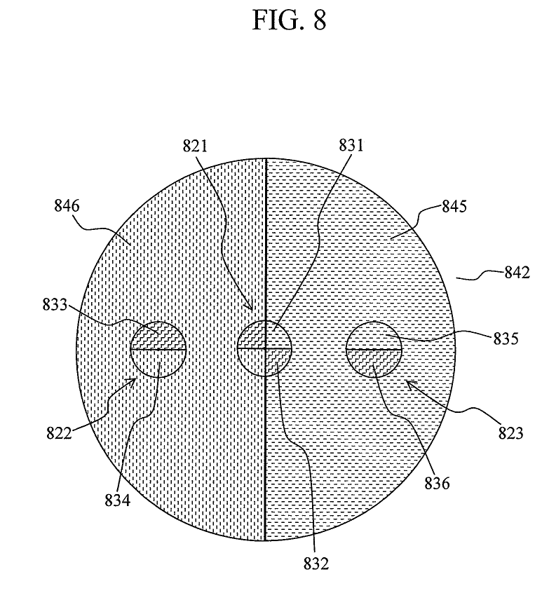

In Embodiment 2 shown in FIG. 2, the diffraction grating 103 and the polarization beam splitter 104 are disposed nearer the semiconductor laser 101 than a collimator lens 407. Thus, the laser light emitted by the semiconductor laser 101 passes through the polarization beam splitter 104 in the form of diverging light. The laser light is then converted into light beam collimated by the collimator lens 407, and then becomes incident on the quarter wavelength plate 105. The reflected light from the dual-layer optical disc 501 has its polarization direction changed by 90° and is then reflected by the polarization beam splitter 104. The reflected light passes through the split wavelength plate 20 and an astigmatism element 406, before being detected by the photodetector 52. The astigmatism element 406 may comprise a cylindrical lens. In the present embodiment, a number of components are disposed between the laser light source 101 and the collimator lens 407 with the polarization beam splitter located at the center. Assuming that the divergence angle of the laser light source and the effective diameter of the optical system are the same, Embodiment 2 is suitable for reducing the size of the optical pickup apparatus.

### Embodiment 3

In Embodiment 3, a split wavelength plate shown in FIG. 10 is used. The split wavelength plate 21 is inserted in the optical path in place of the split wavelength plate 20 of Embodiment 1. The region of influence of interference from the adjacent layer due to the sub-beams differs from that in the case of the split wavelength plate 20, as mentioned above. Assuming that four-quadrant photodetectors 541, 544, and 545 having the same configuration are used, the inputs from the four-quadrant detectors 544 and 545 into the electronic circuit 52 need to be changed.

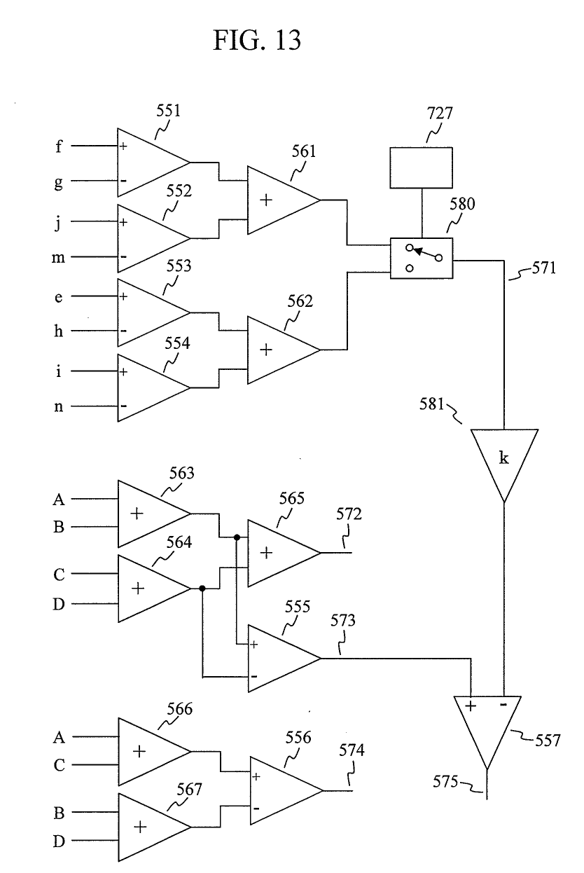

FIG. 13 shows a signal processing circuit configured such that the push-pull signals for the sub-beams are formed by a diagonal combination of the four-quadrant detectors. When the relevant layer is changed, a push-pull signal from a diagonal combination having less influence from the adjacent layer is selected by a switch element 580, which is controlled by a layer selection control circuit 727. While the circuits of FIGS. 12 and 13 have been described as being separate, they can be composed as a single circuit by means of an input signal selection switch.

### Embodiment 4

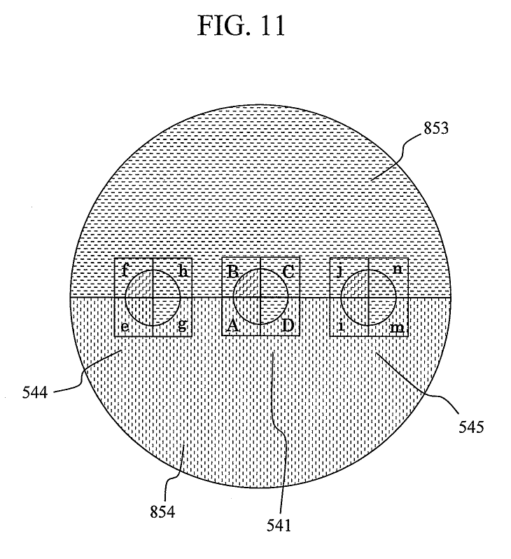

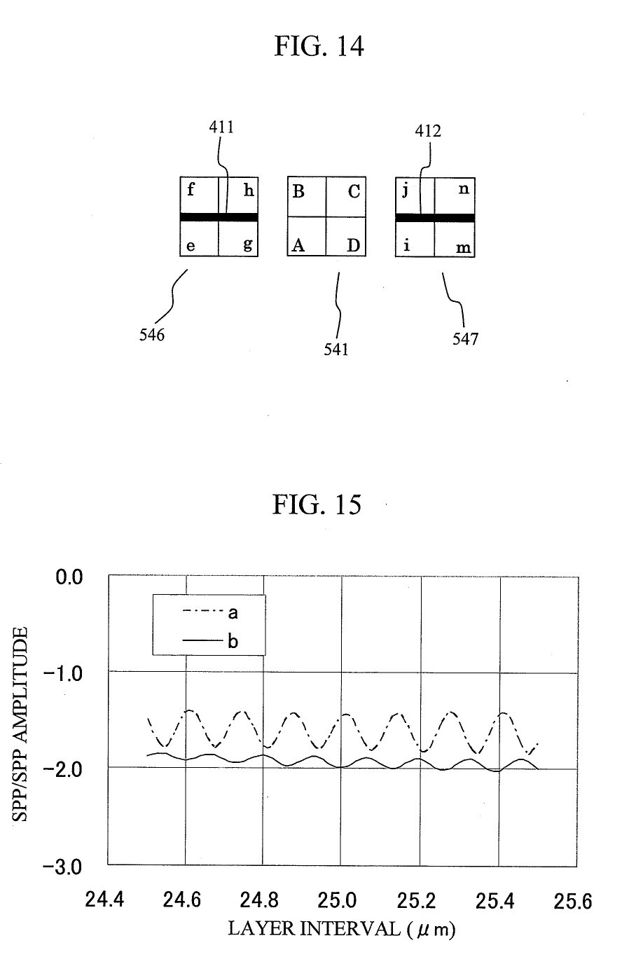

In Embodiment 4, the sensitive region of the detector 52 of Embodiment 1 is modified as shown in FIG. 14, where the central portion of each of the four-quadrant detectors 546 and 547 for detecting sub-beams is blocked by light shield portions 411 and 412. In this case, the direction of light-shield is the track direction of the optical disc. Namely, the longitudinal direction of the light shield portions 411 and 412 corresponds to the track direction of the optical disc. When assembling the optical pickup, it is not necessarily possible to fix the photodetector at a perfectly ideal position; there is also the possibility that the position of the photodetector might be shifted with respect to the three beams, due to changes with time. Regarding the interference between the sub-beams and the reflected light from the adjacent layer, a region with interference and a region without interference are adjacent to each other, as shown in FIG. 9 or 11. Thus, there is the possibility that a region with large interference might enter into the detection sensitive portion due to positional changes in the photodetector over time. In order to prevent this, the light shield region having a certain width is provided at the position of division of the four-quadrant detector.

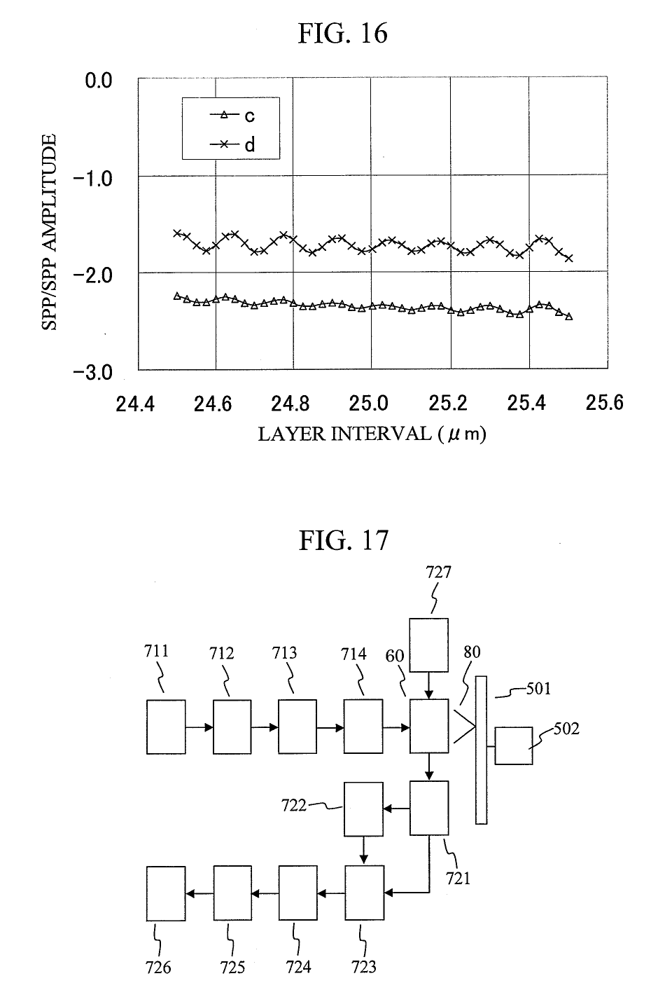

FIG. 15 shows the result of calculation of fluctuation in the sub-push-pull signal (SPP) 571 of FIG. 12. The relevant layer is a layer nearer to the objective lens 404. The wavelength used is 0.405 μm, the NA of the objective lens is 0.85, and the track pitch is 0.32 μm. The magnification of the detection system is approximately ×22, and, for the positioning of the detection system, the detector as a whole was shifted in the track direction by 10 μm. During the calculation, the SPP was calculated while the interlayer distance was changed and in consideration of the interference of the two layers, on the assumption that the main-beam spot position is on-track while the sub-beam positions are fixed at positions shifted by a half track. Since this SPP does not involve a change in track positions, fluctuations in the SPP due to interference can be calculated. The horizontal axis of FIG. 15 shows the interlayer distance between two recording layers, while the vertical axis shows the SPP signal normalized by the SPP amplitude. A solid line b shows the SPP signal upon detection of a portion where there is no influence of interference. For comparison purposes, the SPP signal by a conventional method involving a signal detected by the split detector as a whole is indicated by a broken line a. In the conventional method, the width of fluctuation is 43%; in the present embodiment, the width is 16%, thus indicating a decrease in the fluctuation of the SPP. In FIG. 16, as a calculation condition, the sub-detector was provided with a light-shield of 10 μm at the center, as shown in FIG. 14. While the detector as a whole was shifted in the track direction by 10 μm, the detector in the present example was further shifted in a direction perpendicular to the track direction of the optical disc by 10 μm for comparison purposes. A line d indicated by “x” shows the case where the detector was shifted in a direction perpendicular to the track direction of the optical disc by 10 μm; a line c indicated by triangles shows the case where there was no shifting of the detector in the perpendicular direction. The fluctuations were 26% and 23%, respectively, both indicating a decrease in the SPP fluctuation over the conventional method.

Thus, in accordance with the invention, the phenomenon in which the tracking error signal fluctuates in response to the fluctuation in the interlayer distance can be reduced. The sub-push-pull signal fluctuates as the reflected light from the adjacent layer and the sub-beams for tracking interfere with each other, where the phase difference between them varies depending on the interlayer distance. In accordance with the invention, the influence of interference of the reflected light from the adjacent layer can be reduced, so that the fluctuation in the tracking error signal can be reduced. In this way, it becomes possible to control the laser light irradiation position with high accuracy and to accurately determine the laser irradiated position during reading and writing, so that improved signal quality can be obtained.

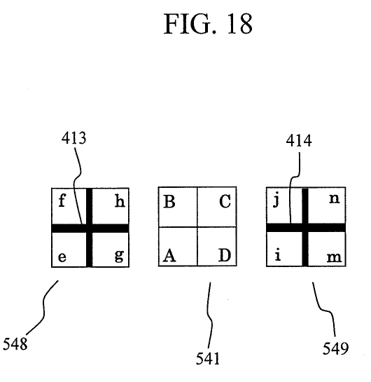

In order to apply the present embodiment when using the split wavelength plate of FIG. 10, the sensitive region of the detector 52 may be modified as shown in FIG. 18. Namely, the boundaries in each of the four-quadrant detectors 548 and 549 for the detection of sub-beams are light-shielded by cross-shaped light shield portions 413 and 414, respectively.

### Embodiment 5

FIG. 17 shows an embodiment of the optical disc drive apparatus in which the fluctuation of the SPP can be reduced. Using a layer selection control circuit 727, the focal point position of the objective lens within the optical pickup 60 is aligned with a selected layer, and a combination of detectors such that interference can be minimized is selected. Circuits 711 to 714 are used for recording data in the multilayer optical disc 501. Numeral 711 designates an error-correcting encoding circuit, by which an error correcting code is added to data. Numeral 712 designates a record encoding circuit, by which data is modulated by the 1-7PP method. Numeral 713 designates a record compensating circuit for generating write pulses adapted to the mark length. Based on a generated sequence of pulses, the semiconductor laser drive circuit 714 drives the semiconductor laser within the optical pickup 60 so as to modulate the laser light 80 emitted by the objective lens. The optical disc 501, which is freely detachable from a disc mount portion, is rotated by a motor 502. The optical disc 501 is formed thereon with a phase-change film which becomes amorphous upon being heated with laser light and then rapidly cooled and which becomes crystalline upon slow cooling. These two states have different reflectivities, enabling the formation of marks. In a written state, no high-frequency superposition, which would reduce the coherency of laser light, is effected, so that the reflected light from the adjacent layer and the reflected light from the relevant layer tend to interfere with each other. Thus, in the absence of some measure to reduce the fluctuation in the SPP, problems may develop, such as a tracking error or the erasing of data in an adjacent track. In the present embodiment, the optical pickup 60 has adopted any of the optical pickups according to Embodiments 1 to 4, whereby no problem of tracking occurs even in dual-layer optical discs.

Circuits 721 to 726 are used for reading of data. The circuit 721 is an equalizer for improving the signal-to-noise ratio near the minimum mark length. Its signal is inputted to the PLL circuit 722 by which the clock is extracted. The data signal processed by the equalizer is digitized by the A-D converter 723 at the timing of the extracted clock. Numeral 724 is a PRML (Partial Response Maximum Likelihood) signal processing circuit, which carries out Viterbi decoding. In the record decoding circuit 725, decoding is performed in accordance with the rules of modulation by the 1-7PP method, and data is reproduced by the error correcting circuit 726.

In accordance with the invention, the influence of the reflected light from an adjacent layer that is produced when reading a dual-layer optical disc on an optical disc drive apparatus can be reduced. When reading or writing a multilayer optical disc, it is necessary to accurately control the tracking position of laser light with respect to the optical disc based on an error signal. If there is reflected light from the adjacent layer, the tracking position can be displaced due to a shift in the error signal caused by interference, making it impossible to accurately read the data signal or to accurately determine the write position. In accordance with the present invention, such problems can be prevented.

What is claimed is:

1. An optical pickup apparatus comprising:
a laser light source;
a focusing optical system for dividing laser light from the laser light source into a main beam and a sub-beam, and focusing the main beam and the sub-beam onto a target recording layer of a dual-layer optical disc; and
a detection optical system for detecting reflected light from the target recording layer of the dual-layer optical disc,
wherein the detection optical system comprises:
an optical element having two regions divided by a straight line for causing the polarization state of the reflected light that has passed through each of the regions to become perpendicular to each other;
a four-quadrant detector for detecting the main beam reflected by the target recording layer; and
a four-quadrant detector for detecting the sub-beam reflected by the target recording layer,
wherein the four-quadrant detector for detecting the sub-beam detects a portion that has a reduced influence from the main beam reflected by another recording layer.

2. The optical pickup apparatus according to claim 1, wherein the detection optical system comprises an astigmatism optical system, and wherein the optical element causes the reflected light that has passed through the two regions to become linearly polarized light whose direction of polarization is perpendicular to each other.

3. The optical pickup apparatus according to claim 1, wherein the detection optical system comprises an astigmatism optical system, and wherein the optical element causes the reflected light that has passed through the two regions to become circularly polarized light whose rotation direction is opposite to each other.

4. The optical pickup apparatus according to claim 1, wherein the straight line dividing the optical element is perpendicular to the track direction of the dual-layer optical disc.

5. The optical pickup apparatus according to claim 4, wherein the four-quadrant detector detecting the sub-beam has a striped portion having no sensitivity at the boundary of detection elements adjacent to each other in the track direction of the dual-layer optical disc.

6. The optical pickup apparatus according to claim 1, wherein the straight line dividing the optical element is parallel to the track direction of the dual-layer optical disc.

7. The optical pickup apparatus according to claim 6, wherein the four-quadrant detector detecting the sub-beam has a cross-shaped portion having no sensitivity at the boundary of adjacent detection elements.

8. The optical pickup apparatus according to claim 1, wherein detection elements of the four-quadrant detector for detecting the sub-beam is switched depending on the target recording layer.

9. An optical disc drive comprising:
a laser light source;
a focusing optical system for dividing laser light from the laser light source into a main beam and a sub-beam and focusing the main beam and the sub-beam onto a target recording layer of a dual-layer optical disc;
a detection optical system comprising: an astigmatism element; a four-quadrant detector for detecting the main beam reflected by the target recording layer of the dual-layer optical disc; a four-quadrant detector for detecting the sub-beam reflected by the target recording layer; and an optical element having two regions divided by a straight line for causing the polarization state of the reflected light that has passed through each of the regions to become perpendicular to each other;
a signal processing circuit for producing a focusing error signal, a tracking error signal, and a data signal based on the outputs from the four-quadrant detector detecting the main beam and the four-quadrant detector detecting the sub-beam; and
a layer selection control unit,
wherein the signal processing circuit produces the tracking error signal using the outputs of those of detection elements of which the four-quadrant detector for detecting the sub-beam is composed that have a reduced influence of interference by the main beam reflected by another recording layer, depending on the recording layer selected by the layer selection control unit.

10. The optical disc drive according to claim 9, wherein the straight line that divides the optical element is perpendicular to the track direction of the dual-layer optical disc, and wherein the signal processing circuit produces the tracking error signal using the outputs from two of four detection elements of which the four-quadrant detector for detecting the sub-beam is formed that are adjacent to each other in a direction perpendicular to the track direction.

11. The optical disc drive according to claim 9, wherein the straight line that divides the optical element is parallel to the track direction of the dual-layer optical disc, and wherein the signal processing circuit produces the tracking error signal using the outputs of those two of four detection elements of which four-quadrant detector for detecting the sub-beam is composed that are positioned in a diagonal direction, depending on the recording layer selected by the layer selection control unit.
